(19) United States
(12) Patent Application Publication
(10) Pub. No.: US 2002/0012900 A1
(43) Pub. Date: Jan. 31, 2002

(54) Song and image data supply system through internet

(76) Inventor: Ryong-Soo Song, Inchon-city (KR)

Correspondence Address: STAAS & HALSEY LLP, 700 11TH STREET, NW, SUITE 500, WASHINGTON, DC, 20001, US

(21) Appl. No.: 09/917,860

(22) Filed: Jul. 31, 2001

Related U.S. Application Data
(63) Continuation-in-part of application No. 09/331,900, filed on Jul. 9, 1999, now Pat. No. 6,267,600.

(30) Foreign Application Priority Data
Mar. 12, 1998 (KR) 98-8310
Dec. 2, 1998 (KR) PCT/KR98/00397

(51) Int. Cl. G10H 1/36

(52) U.S. Cl. 434/307 A

(57) ABSTRACT

An apparatus to supply sound and image data to a lyrics accompaniment device through an internet work system by which images and captions appearing on a monitor of the lyrics accompaniment device and the corresponding sound data being output from a speaker can be downloaded through the internet work system so that a user can selectively receive new pieces of music without being tied to time and place.

### CROSS-REFERENCE TO RELATED APPLICATIONS

This application is a continuation-in-part application of U.S. patent application Ser. No. 09/331,900, which was filed in the U.S. Patent and Trademark Office on Jul. 9, 1999, and which claims the benefit of Korean Application No. 98-8310, filed Mar. 12, 1998, in the Korean Patent Office and International Application No. PCT/KR 98/00397 filed Dec. 2, 1998, the disclosures of which is incorporated herein by reference.

### BACKGROUND OF THE INVENTION

1. Field of the Invention

The present invention relates to an apparatus for supplying sound and image data to a lyrics accompaniment device, and more particularly, to a song and image data supply system through internet by which images and captions appearing on a monitor of the lyrics accompaniment device and the corresponding sound data being output from a speaker can be downloaded through an internet work system, so that a user can selectively receive new pieces of music without being tied to time and place.

2. Description of the Related Art

Generally, a lyrics accompaniment device is an apparatus for allowing a user easily to sing a song to the accompaniment melodies recorded therein even without any specific musical instruments. The conventional lyrics accompaniment device is provided therein with a memory device in which various melodies and the corresponding images and captions are stored. When a user selects any melody stored in the memory device, the device outputs the melody and the corresponding images and captions to a speaker and the screen of a monitor thereof, respectively. So, a user can sing a song to the sound accompaniment of the melody output from the speaker, watching the images and captions appearing on the screen of the monitor.

Since such a conventional lyrics accompaniment device outputs only melodies stored in the memory device and cannot provide a user with any new piece of music, a user cannot sing the song to the accompaniment of the new melodies that are not stored in the memory device. In order to sing a song to the accompaniment of the melody of a new piece of music, a user has to exchange the existing memory device provided in the accompaniment device with a new memory device stored therein with a new piece of melody of the new music, or update the existing memory device by inputting a melody of the new music to the memory device by a separate input device.

However, there is a problem in that a user has to visit a commercial agent that provides sound and image data to exchange the existing memory device with a new memory device stored therein with a new piece of music, or to update the existing memory device by inputting the new piece of music to the memory device at the agent, thereby requiring, a lot of time spent in updating the existing memory device of exchanging the existing memory device with a new memory device.

### SUMMARY OF THE INVENTION

In order to solve the above and other problems, it is an object of the present invention to provide a song and image data supply system through the internet by which images and captions appearing on a monitor of the lyrics accompaniment device and the corresponding sound data being output from a speaker can be downloaded through an internet work system.

Additional objects and advantages of the invention will be set forth in part in the description which follows and, in part, will be obvious from the description, or may be learned by practice of the invention.

In order to accomplish the above and other objects of the present invention, a song and image data supply system according to an embodiment of the invention includes a server computer to store music and image data to be provided to a user or a company, a user computer linked to the server computer to download the music and image data, and a recorder to store the downloaded music and image data.

According to an aspect of the present invention, the user computer is programmed to allow a user allows to be registered as a member in the server computer and the user computer is linked to the server computer to thereby receive the music and the image data to be downloaded from the server computer whenever a user requires.

According to another aspect of the present invention, the recorder stores the downloaded music and image data from the server computer in a memory device.

According to yet another aspect of the present invention, the memory device is detachably coupled to an accompaniment device.

According to still another aspect of the present invention, the server computer allows encoded data to be directly recorded in the memory device through the recorder linked to the user computer when supplying data to the user computer.

According to another embodiment of the present invention, the recorder comprises a data input/output interface to transmit music and image data from a user computer, a microcomputer connected to the interface to perform a program in response to a control command of the user computer and to control the recording of the music and image data in a memory device through a logic array, a memory interface to create addresses and data signals appropriate to the rule to of the memory device to record the music and the image data therein, and connectors to connect the memory interface to the memory device to store the music and image data output from the memory interface.

According to a further aspect of the present invention, the memory device is a memory card or any storage device that is detachably mounted in lyrics accompaniment devices so that it is easy for a user to carry.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a block diagram showing a system of an embodiment of the present invention;

FIG. 2 is a block diagram showing the connection structure between a recorder and a user computer according to an embodiment of the present invention;

FIG. 3 is a perspective view showing an accompaniment device including microphone and a receiver therefor according to an embodiment of the present invention;

FIG. 4 is a block diagram illustrating a microphone for the accompaniment according to an embodiment of the present invention;

FIG. 5 is a circuit diagram illustrating image control data transmitting device as shown in FIG. 4.; and

FIG. 6 is a block diagram showing a receiver according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

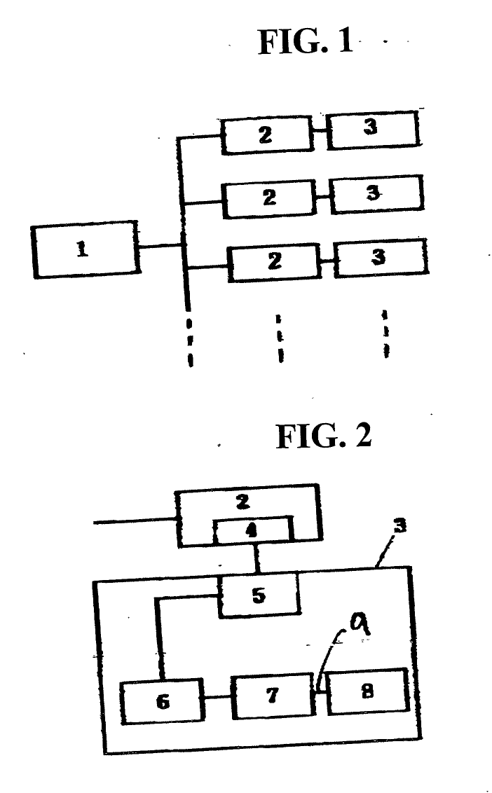

FIG. 1 is a block diagram illustrating the song and image data supply system according to an embodiment of the present invention, which comprises a server computer 1, a user computer 2 having a corresponding recorder 3. The server computer 1 stores the music and image data to be supplied to a user through the internet work system, and directly inputs encoded data to the recorder 3 that is connected to the user computer 2 while the data is transmitted to the user computer 2.

The user computer 2 is linked to a home page of the server computer 1 using the internet to thereby receive the music and the image data downloaded from the server computer 1. After a user is registered as a member in the server computer 1, if the user wants, the user computer 2 is linked to the server computer 1 and programmed so that the music and the image data selected by the user are downloaded from the server computer 1 to the user computer 2.

As shown in FIG. 2, the recorder 3 comprises a data input/output interface 5, a microcomputer 6 connected to the interface 5, a memory interface 7 connected to the microcomputer 6, a connector 9 to connect the memory interface 7 to a memory device 8, and the memory device 8.

The data input/output interface 5 transmits the music and the image data from the user computer 2 through an interface 4. The microcomputer 6 performs a program in response to a control command of the user computer 2 and controls the storage of the music and the image data in the memory card 8 through the memory interface 7. The memory interface 7 serves to generate addresses and data signals appropriate to a rule of the memory card 8 to store the music and image data therein.

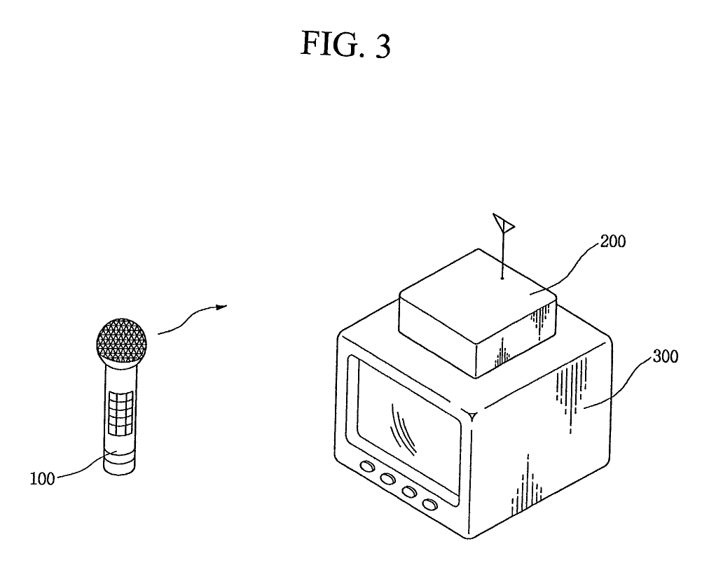

The memory card 8 stores the music and image data output from the memory interface 7. It is preferred that the memory card 8 be detachably mounted to the lyrics accompaniment device so that it is convenient to supply it to a user or an agent and to be carried along with it. Examples of such a lyric accompaniment device is disclosed in U.S. patent application Ser. No. 09/331,900, which is incorporated herein by reference. One such lyric accompaniment device is shown in FIGS. 3-6. Specifically, the memory card 8 would be stored in the microphone 100, either detachably or permanently, after storing the data received through the memory interface 7.

Now the operation of the song and image supply system through the internet according to an embodiment of the present invention will be explained below. A user contacts the server computer 1 using the user computer 2 to receive song and image data corresponding to a new piece of music or other music. At that time, the user can select selected data and delete non-selected data, thereby effectively managing the song and image data in the lyrics accompaniment device. The song and image data downloaded from the server computer 1 are stored in a database on the user computer 2 to be controlled by a user. The song and image data are encoded when being supplied to a user over the internet. Thereafter, the encoded data are directly stored in the memory card 8 through the user's recorder 3, thereby preventing the data from being lost or drained.

A user can search song and image data through the user computer 2 after registering as a member on the server computer 1 by utilizing the user computer 2. Since all of the above-mentioned procedures (i.e., searching and selecting a list of the database of the server computer 1 and downloading the selected data) is computerized according to an embodiment of the present invention, data concerning user's age, occupation, favorite songs, etc. can be stored in a database on the server computer 1. Data concerning the user's registration as a member may be used to improve services to the user. The server computer 1 can function as a home page of the song and image data supply system for public information of a company, receipt of users' opinions, production guide of a company, etc. in addition to supplying the song and image data to the user computer 2.

In order for a user to link the user computer 2 to the server computer 1 and search a database therein, the user should follow security instructions from the server computer 1 with an identification code (ID) and a secret number. Accordingly, such a set of procedures prevents data of the database in the server computer 1 from being divulged through the internet to any other person who is not registered as a member on the server computer 1. In addition, a user just can search, select and receive a list of data, but cannot control or manipulate data themselves in the server computer 1. The server computer 1 is open to users any time everyday so that users can link, search, select, and receive data stored in the server computer 1.

Accordingly, there is an advantage that the song and image data supply system can provide a new piece of music and image data that are downloaded through internet to lyrics accompaniment devices by utilizing the memory device storing the downloaded data without being tied to time and places.

An example of a lyric accompaniment device is shown in FIGS. 3 through 6.

FIG. 3 is a perspective view showing the microphone for automatic accompaniment and a receiver therefor according to an embodiment of the present invention. Referring to FIG. 3, reference numeral 100 indicates the microphone for automatic accompaniment. The microphone 100 serves to store the accompaniment melody selected by a user and the mixed voice signal mixed with the song voice signal according to the accompaniment melody, to convert the mixed voice signal into a FM signal to transmit it, and to convert the image control data according to the selected accompaniment melody into a FM signal to transmit it.

Reference numeral 200 indicates a receiver according to an embodiment of the present invention. The receiver 200 serves to receive the mixed voice signal transmitted from the microphone 100 for automatic accompaniment to output it to the television receiver set 300, to generate a caption image of song words and a background image according to the image control data transmitted from the microphone 100, and to output the background image and caption image to the television receiver set 300 so that the images appear on the screen the television receiver set 300.

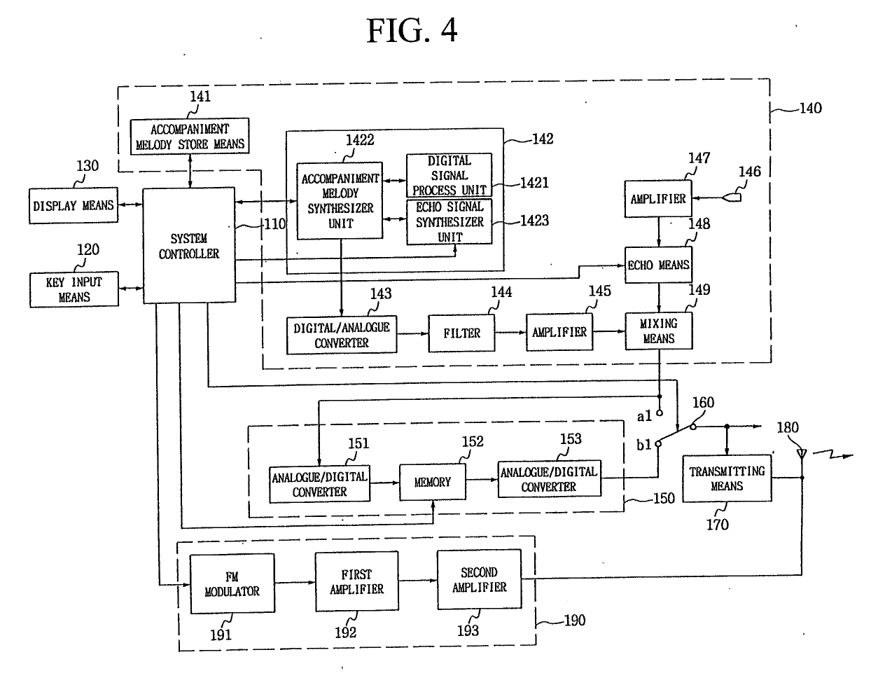

FIG. 4 is a block diagram showing the microphone 100 for automatic accompaniment according to an embodiment of the present invention. The microphone 100 for automatic accompaniment as shown in FIG. 4 comprises a system controller 110 for controlling transmission of a song and an accompaniment melody selected by user's manipulation, for controlling store and playback, and for controlling transmission of image control data corresponding to caption image for song words and a background image according to the selected accompaniment; a key input means 120 for inputting an operation instruction into the system controller 110; display means 130 for displaying an operation state in response to control of the system controller 110; mixed voice signal output means 140 for outputting an accompaniment melody selected by a user according to control of the system controller 110 and at the same time mixing the song voice signal and the accompaniment melody; record and playback means 150 for storing and outputting the mixed voice signal of the mixed voice signal output means 140 in response to control of the system controller 110; a switch 160 for outputting selectively the output signal of the output means 140 and record/playback means 150 in response to control of the system controller 110; transmitting means 170 for converting the mixed voice signal selected by the switch 160 into a FM signal to transmit it through an antenna 180; and image data transmitting means 190 for converting the image control data outputted from the system controller 110 into a FM signal to transmit it through the antenna 180.

The mixed voice signal output means 140 comprises accompaniment melody store means 141 for storing in separate zone of memory units accompaniment melody data for lyrics, nursery songs, hymn and the like to thereafter output the selected accompaniment melody in response to control of the system controller 110, accompaniment melody synthesizing means 142 for controlling the accompaniment melody output from the store means 141 in response to control of the system controller 110 to synthesize and output the corresponding echo signal, a digital-to-analogue converter 143 for converting the output signal of the accompaniment melody synthesizing means 142 to an analogue signal, a filter 144 for filtering the output signal of the converter 143, an amplifier 145 for amplifying the output signal of the filter 144, an amplifier 147 for amplifying a song sound signal inputted through a microphone 146, echo means 148 for echoing the output signal of the amplifier 147 in response to control of the system controller 110, mixing means 149 for mixing the output signals of the amplifier 145 and echo means 148.

According to an embodiment of the present invention, the memory 8 of FIG. 2 comprises the accompaniment melody store means 141 shown in FIG. 4.

The accompaniment melody synthesizing means 142 includes a digital signal processing unit 1421 for converting the accompaniment melody read by the store means 141 into a digital signal, an accompaniment melody synthesizer unit 1422 for synthesizing the output signal of the digital signal processing unit 1421 into an accompaniment melody signal, and echo signal synthesizer unit 1423 for echoing the signal synthesized in the accompaniment melody synthesizer unit 1422 in response to a user's selection.

The record and playback means 150 comprises an analogue-to-digital converter 151 for converting the output signal of the mixed voice signal output means 140 into a digital signal, a memory unit 152 for storing and outputting the output signal of the analogue/digital converter 151 in response to control of the system controller 10, and a digital to analogue converter 153 for converting the output signal of the memory unit 152 into an analogue signal to thereafter output it to the switch 160.

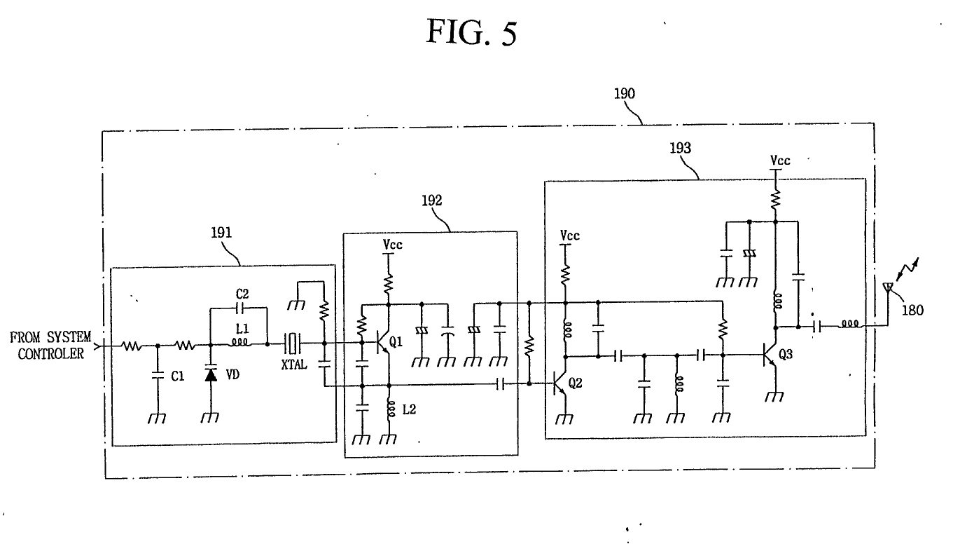

The image control data transmitting means 190, as shown in the FIG. 5, comprises a FM modulator 191, a first amplifier 192 and a second amplifier 193. The FM modulator 191 generates a FM modulating signal while a crystal XTAL oscillates according to a time constant of oscillation predetermined by a variable capacitance diode VD, condenser C2 and coil L1, where the variable capacitance diode VD varies in its capacitance according to the image control data outputted from the system controller 110. The first amplifier 192 serves to amplify the output signal of the FM modulator 191 with a transistor Q1. The second amplifier 193 serves to amplify the output signal of the first amplifier 192 with transistors Q2 and Q3 to thereafter transmit it through the antenna 180.

With the microphone for automatic accompaniment thus constructed, if a user selects a desired song by manipulating the key input means 120 provided within the microphone prior to singing a song, the system controller 110 is activated to determine the desired accompaniment melody to display it through the display means 130, and also to output the desired accompaniment melody through the accompaniment melody store means 141 and at the same time output the image control data according to the accompaniment melody to the image control transmitting means 190.

The accompaniment melody outputted from the accompaniment melody store means 141 is input into the accompaniment melody synthesizing means 142 through the system controller 110 so that the accompaniment melody is synthesized and outputted. Specifically, the accompaniment melody outputted from the accompaniment melody store means 141 is processed in the digital signal processing unit 1421 of the accompaniment melody synthesizing means 142 as a piano sound signal or signals of any other musical instruments, and synthesized by the synthesizer unit 1422. When the user selects an echo function by manipulating the key input means 120, the accompaniment melody synthesized by the synthesizer unit 1422 is echo-processed by the echo signal synthesizer unit 1423 to be output.

The accompaniment melody outputted from the accompaniment melody synthesizing means 142 is converted into an analogue signal by the digital-to-analogue converter 143, filtered through the filter 144, and amplified by the amplifier 145 to thereafter be outputted to a fixing terminal (a1) of the switch 160 through the mixing means 149.

When the user allows the melody stored in the accompaniment melody store means 141 to be outputted to sing a song, the moving terminal of the switch 160 is electrically connected to the fixing terminal (a1) by the system controller 110. Then, the accompaniment melody outputted from the mixing means 149 is outputted through the switch 160 and converted into an FM signal by the transmitting means 170 to be wirelessly transmitted via the antenna 180.

In this state, when a user sings a song to the accompaniment of the melody outputted an audio system, the song sound signal is input to the microphone 146 to be amplified by the amplifier 147, and is echo-processed by the echo means 148 in response to the system controller 110 to thereafter be input to the mixing means 149.

The mixing means 149 serves to mix the accompaniment melody outputted from the amplifier 145 with the song sound signal outputted from the echo means 148. The sound signal mixed by the mixing means 149 is outputted via the switch 160, and converted into a FM signal by the transmitting means 170 to thereafter be transmitted wirelessly via the antenna 180.

During such operations, the mixed sound (voice) signal of the accompaniment melody outputted from the mixing means 149 is converted into a digital signal by the analogue-to-digital converter 151 of the record and playback means 150 and inputted into the memory unit 152. The memory unit 152 successively stores the digital signals outputted from the analogue-to-digital converter 151 in response to address signals outputted from the system controller 110.

And, the image control data according to the accompaniment outputted from the system controller 110 is inputted into the FM modulator 191 and the capacitance of the variable capacitance diode VD varies in response to the image control data, thereby the oscillation time constant predetermined by the variable capacitance diode VD, condenser C2 and coil L1 varies.

As a result, the FM-modulated signal is generated while the oscillation frequency of the crystal XTAL varies in response to the image control data, the FM modulation signal of the image control data generated by the FM modulator 191 is amplified through the transistor Q1 and is again amplified through the transistors Q2, Q3 in the second amplifier 193 to thereafter to be transmitted through the antenna 180.

When the user finishes singing a song and selects playback function by manipulating the key input means 120, the system controller 110 controls the switch 160 so that the moving terminal is electrically connected to the other fixing terminal (b1), and at the same time controls the memory unit 152 of the record and playback means 150 so that the stored signal is outputted in order.

The signal outputted from the memory unit 152 is converted into the analogue signal by the digital-to-analogue converter 153 to thereafter be outputted through the switch 160 and is converted into the FM signal by the transmitting means 170 to thereafter be transmitted through the antenna 180.

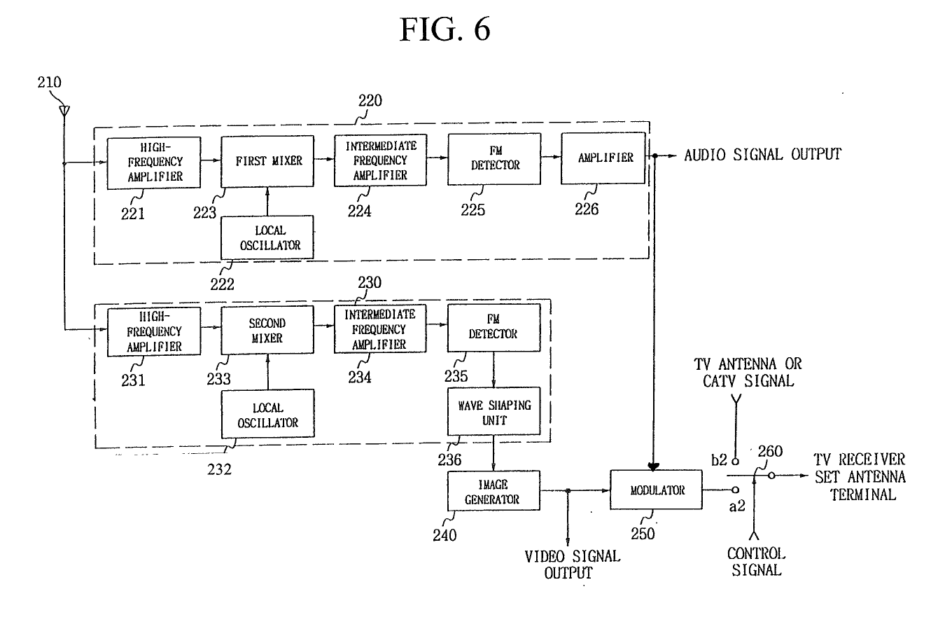

FIG. 6 is a block diagram showing a receiver according to an embodiment of the present invention.

The receiver 200 comprises a first receiving unit 220 for receiving a mixed voice signal in high frequency received through the antenna 210, a second receiving unit 230 for receiving an image control data in high frequency received through the antenna 210, an image generator 240 for generating a background image and caption image of song words according to the image control data received by the second receiving unit 230, a modulator 250 for modulating the mixed sound (voice) signal received by the first receiving unit 220, the background image and caption image of song words generated by the image generator 240 into a television broadcasting signal to be output, and a switch 260 for selecting a television antenna/CATV signal or a modulation signal of the modulator 250 in response to the control signal to output to the antenna terminal of the television receiver set 300.

The first receiving unit 220 comprises a high-frequency amplifier 221 for amplifying a received signal of the antenna 210, a local oscillator 222 for generating a local oscillating signal, a first mixer 223 for outputting an intermediate-frequency signal by mixing output signals of the high frequency amplifier 221 and the local oscillator 222, an intermediate frequency amplifier 224 for amplifying the intermediate frequency signal outputted by the first mixer 223, a FM detector 225 for detecting a mixed voice signal from the output signal of the intermediate frequency amplifier 224, and an amplifier 226 for amplifying the mixed voice signal detected by the FM detector 225.

The second receiving unit 230 comprises a high-frequency amplifier 231 for amplifying a received signal of the antenna 210, a local oscillator 232 for generating a local oscillating signal, a second mixer 233 for outputting an intermediate-frequency signal by mixing output signals of the high frequency amplifier 231 and the local oscillator 232, an intermediate frequency amplifier 234 for amplifying the intermediate frequency signal outputted by the second mixer 233, a FM detector 235 for detecting an image control data signal from the output signal of the intermediate frequency amplifier 234, and a wave shaping unit 236 for wave-shaping the image control data detected by the FM detector 235 to transmit it an image generator 240.

According to the receiver 200 of the present invention thus constructed, the high frequency signal transmitted by the microphone 100 is inputted into the first receiving unit 220 and second receiving unit 230 through the antenna 210.

The first receiving unit 220 serves to generate the intermediate frequency signal by amplifying the received high-frequency signal through the high frequency amplifier 221 and mixing it with the local oscillating signal of the local oscillator 222 through the mixer 223.

The intermediate frequency signal generated by the mixer 223 is amplified through the intermediate frequency amplifier 224, the mixed voice signal is detected by the FM detector 225, and the detected mixed voice signal is amplified by the amplifier 226 to be output.

The second receiving unit 230 generates the intermediate frequency signal by amplifying the received high-frequency signal through the high-frequency amplifier 231 and mixing it with the local oscillating signal of the local oscillator 232 through the mixer 233.

The intermediate frequency signal generated by the mixer 233 is amplified by the intermediate frequency amplifier 234, the image control data is detected by the FM detector 235, and the detected image control data is wave-shaped through the wave shaping unit 236 to thereafter be outputted.

The image control data outputted from the second receiving unit 230 is inputted into the image generator 240.

Then, the image generator 240 generates the caption image of song words and the background image corresponding to the image control data to output.

As a result of such construction, the mixed voice signal outputted from the first receiving unit 220 and the background image and caption image of song words outputted from the image generator 240 are inputted into the audio/video terminal of the television receiver set 300, the television receiver set 300 serves to amplify the inputted mixed audio signal to output it through the speaker and to display the background image and caption image of song words on its screen, thereby a user can sing a song to the accompany of a melody outputted from the speaker, watching the background image and caption image of song words which appear on the screen.

In addition, the mixed audio signal outputted from the first receiving unit 220 and the background image and caption image of song words outputted from the image generator 240 are inputted into the modulator 250, the modulator 250 modulates the inputted mixed audio signal and the background image and caption image of song words into the television broadcasting signal to output it to a fixing terminal a2 of the switch 260.

The switch 260 enables the moving terminal to be connected to the fixing terminal a2 in response to input of the control signal when the receiver 200 is turned-on, the mixed audio signal modulated by the modulator 250 and images of the background and caption are inputted into the television receiver set, the mixed audio signal is outputted through the speaker, and the background image and the caption image appear on the screen the television receiver set, thus the user can sing a song to the accompaniment of the selected melody outputted from the speaker, watching the background image and caption image on the screen.

Further, when the receiver 200 is turned-off, the control signal is not inputted so that the moving terminal of the switch 260 is connected to the other fixing terminal b2, and the user can again watch television as usual.

In the foregoing, storing and playing the mixed audio signal resulting from mixing of the accompaniment melody and song voice signal into the record and playback means 150 was explained as an embodiment. However, the present invention is not restricted to a limit of the record and playback means 150, but can varies in various types. For example, the present invention may be constructed in such a manner that the echo means 148 can be connected to the record and playback means 150 so that only the song sound signal can be stored in the record and playback means 150 and outputted.

As another example, the present invention may be constructed in such a manner that the output signals of the echo means 148 and the amplifier 145 are outputted to two units of the record and playback means 150 in which the song sound signal and accompaniment melody are separately and respectively stored, and when the stored song sound signal and accompaniment melody are played-back, the audio signal and/or accompaniment melody could be selected from the separate two record and playback means 150 to be output.

As the other embodiment, even without providing the microphone 100 with the image control data transmitting means 190, the mixed audio signal of the song voice signal and the accompaniment melody or the song voice signal could be FM-modulated to be transmitted, and alternatively could be recorded and played by the record/playback means 150 to thereafter be FM-modulated to be transmitted, thereby an audio system provided with a FM receiver receives and outputs the signals transmitted from the microphone 100.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A system to supply song and image data through an internet homepage, comprising:
a server computer to store the music and image data to be provided to a user or a company;
a user computer linked to said server computer to receive the music and image data to be downloaded from said server computer, said user computer being linked by a user requirement after the user's registration as a member on said sever computer, said user computer being programmed so that the user receives the user's selected music and image data downloaded from said server computer; and
a recorder connected to said user computer to store the music and image data that was downloaded to said user computer in a memory device, the memory device being detachably coupled to a lyrics accompaniment device.

2. The system as claimed in claim 1, wherein said server computer comprises a home page of the song and image data supply system to provide public information of a company, receipt of users' opinions, production guide of a company in addition to inputting encoded data to the memory device as the song and image data is supplied to said user computer.

3. The system as claimed in claim 1, wherein said user computer searches and selects a list of the music and image data from a database of said server computer.

4. The system as claimed in claim 1, wherein said server computer downloads the data selected by the user to said user computer.

5. The system as claimed in claim 1, wherein said server computer further comprises a database contain the user's age, occupation, favorite song.

6. The system as claimed in claim 1, wherein said user computer is programmed to allow the user allows to be registered as a member in said server computer, and said user computer is linked to said server computer to thereby receive the music and image data from said server computer whenever a user requires.

7. The system as claimed in claim 1, wherein said recorder stores the downloaded music and image data from said server computer in the memory device.

8. The system as claimed in claim 1, wherein the memory device is removable from said recorder to be detachably coupled to a lyrics accompaniment device.

9. The system as claimed in claim 1, wherein said server computer directly inputs encoded data to the memory device through said recorder linked to said user computer when supplying data to said user computer.

10. The system as claimed in claim 1, wherein said recorder further comprises
a data input/output interface to transmit the music and image data from said user computer,
a microcomputer connected to the interface to perform a program in response to a control command of said user computer and to control the recording of the music and image data in the memory device through a logic array,
a memory interface to create addresses and data signals appropriate to a rule of the memory device to record the music and image data therein, and
a connector to connect the memory interface to the memory device used to store the music and image data output from the memory interface.

11. The system as claimed in claim 1, wherein the memory device comprises a memory card or a storing device that is detachably be mounted in the lyrics accompaniment device and is portable.

12. A system to supply song and image data through an internet work system, comprising:
a server computer to store the music and image data to be provided a user or a company;
a user computer linked to said server computer to receive the music and image data being downloaded from said server computer;
a lyrics accompaniment device to allow a user to sing a song to the accompaniment of melodies; and
a recorder connected to said user computer to store the music and image data downloaded to said user computer in a memory device, the memory device being detachably coupled to said lyrics accompaniment device.
